(19) United States
(12) Patent Application Publication
(10) Pub. No.: US 2008/0080575 A1
(43) Pub. Date: Apr. 3, 2008

(54) LASER WITH HEATER TO REDUCE OPERATING TEMPERATURE RANGE AND METHOD OF USING SAME

(75) Inventor: Stefan J. Murry, Houston, TX (US)

Correspondence Address: APPLIED OPTOELECTRONICS, INC., 13111 JESS PIRTLE BLVD., SUGAR LAND, TX, 77478, US

(73) Assignee: APPLIED OPTOELECTRONICS, INC., Sugar Land, TX (US)

(21) Appl. No.: 11/748,580

(22) Filed: May 15, 2007

Related U.S. Application Data
(60) Provisional application No. 60/827,331, filed on Sep. 28, 2006.

(51) Int. Cl. H01S 3/02

(52) U.S. Cl. 372/34

(57) ABSTRACT

A laser for use in a laser transmitter may be heated to maintain an operating temperature of the laser above a temperature floor such that the operating temperature of the laser is allowed to vary within a reduced operating temperature range. The reduced operating temperature range of the laser thus allows the wavelength emitted by the laser to vary within a reduced range of emission wavelengths. In other words, the temperature floor reduces the temperature range experienced by the laser, which reduces the wavelength excursion. The operating temperature of the laser may be allowed to rise above the temperature floor without cooling the laser to stabilize the operating temperature.

### CROSS-REFERENCE TO RELATED APPLICATIONS

This application claims the benefit of co-pending U.S. Provisional Patent Application Ser. No. 60/827,331, filed on Sep. 28, 2006, which is fully incorporated herein by reference.

### TECHNICAL FIELD

The present invention relates to lasers in optical transmission systems and more particularly, to a laser with a heater to reduce the operating temperature range.

### BACKGROUND INFORMATION

Lasers, such as semiconductor lasers, may be used in a variety of applications such as high-bit-rate optical communications. In optical communications applications, semiconductor lasers may be used to generate optical carrier signals to be transmitted over optical fibers. Wavelength-division multiplexing (WDM) techniques may be employed by using different wavelengths of laser light to carry different signals on a single optical fiber. In course WDM (CWDM) systems, for example, the ITU (International Telecommunication Union) has standardized a 20 nanometer (nm) channel spacing grid using the wavelengths between 1271 nm and 1611 nm.

The emission wavelength of a semiconductor laser may vary with temperature due to index of refraction changes and other factors. If a laser has a wavelength temperature fluctuation of about 0.1 to 0.12 nm per degree Celsius, for example, the wavelength may vary about 13-14 nm over an operating temperature range of about −40° C. to 85° C. In many optical communications applications, only a limited amount of wavelength shift can be tolerated. Because of the spacing between channels in WDM systems, for example, wavelength shifting caused by temperature drift may result in channel crosstalk. A wavelength variance in the range of 13-14 nm is close to the maximum tolerance allowable in some systems and thus allows little manufacturing tolerance for such lasers. When WDM systems are used in temperature controlled environments (e.g., indoors), this wavelength shifting may be minimized. The use of optical transmission systems in other environments, however, has resulted in a need to control the temperature within the laser transmitter to minimize wavelength shift.

One approach employed to control temperature within a laser transmitter is to incorporate a thermoelectric cooler (also called a TEC or Peltier cooler) inside the laser package. Typically such a cooler is used to stabilize the temperature of the laser chip and other optical or electronic components that are inside the laser package. A TEC is often used in a butterfly-type laser package housing.

Although temperature stabilization using thermoelectric coolers may be effective in preventing wavelength shifting, temperature stabilization of this type is costly, adds to the complexity of the manufacturing process, and may have an adverse impact on the reliability of the laser module. The use of a thermoelectric cooler is also comparatively bulky, necessitating a larger physical size for the module (e.g., a butterfly-type housing). The use of a thermoelectric cooler also typically draws a large amount of electrical current in operation.

### BRIEF DESCRIPTION OF THE DRAWINGS

These and other features and advantages will be better understood by reading the following detailed description, taken together with the drawings wherein:

FIG. 1 is a schematic diagram of a laser transmitter including a laser heating system, consistent with an embodiment of the present invention.

FIG. 2 is a side view of a laser package including a laser on a submount with a film resistor heater, consistent with an embodiment of the present invention.

FIG. 3 is a flow chart illustrating a method of reducing an operating temperature range of a laser, consistent with an embodiment of the present invention.

### DETAILED DESCRIPTION

A laser for use in a laser transmitter or combined transmitter-receiver (usually referred to as a transceiver), consistent with embodiments of the present invention, may be heated to maintain an operating temperature of the laser above a temperature floor such that the operating temperature of the laser is allowed to vary within a reduced operating temperature range. The reduced operating temperature range of the laser thus allows the wavelength emitted by the laser to vary within a reduced range of emission wavelengths. In other words, the temperature floor reduces the temperature range experienced by the laser, which reduces the wavelength excursion. In one embodiment, the operating temperature of the laser is allowed to rise above the temperature floor without cooling the laser to stabilize the operating temperature. Although exemplary embodiments are described herein in connection with particular types of lasers used in laser transmitters in optical communications systems, such as wavelength division multiplexed (WDM) systems, embodiments of the invention may be used with other types of lasers in other types of optical systems.

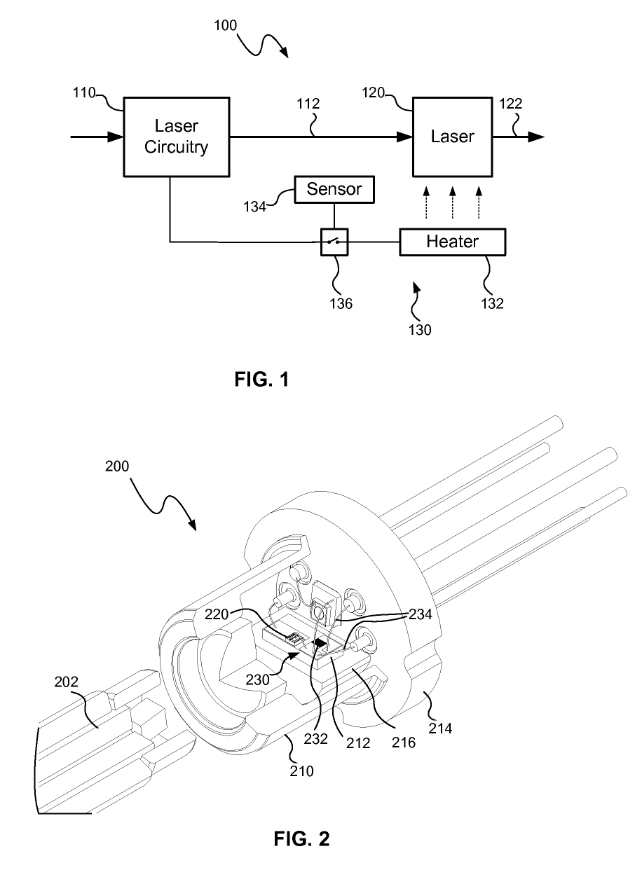

Referring to FIG. 1, one embodiment of a laser transmitter 100 includes laser circuitry 110 coupled to a semiconductor laser 120 (e.g., a laser diode) and a laser heating system 130. The laser circuitry 110 provides electrical signals 112 for modulating the laser 120 to produce a modulated laser output 122 at the emission wavelength(s) of the laser 120. The laser circuitry 110 may include laser drive circuitry and/or laser interfacing circuitry for interfacing with the drive circuitry and for conditioning or modifying the electrical signals applied to the laser 120.

The semiconductor laser 120 may operate at a single wavelength but that wavelength may change due to fluctuations in operating temperature. In particular, the laser 120 may be configured to emit a predefined center wavelength and to have a wavelength temperature fluctuation such that the emission wavelength of the laser 120 varies within a range of wavelengths around the center wavelength. In a WDM system, for example, the laser 120 may be configured to emit a center wavelength within the range of 1271 nm to 1611 nm and may have a wavelength temperature fluctuation of about 0.1 to 0.12 nm per degrees Celsius (nm/° C.).

The laser heating system 130 may include a laser heater 132 positioned sufficiently close to the laser 120 to maintain the operating temperature of the laser 120 above a temperature floor. One example of the laser heater 130 is a resistor heater, which may receive current from the laser circuitry 110. In one embodiment, the laser 120 is uncooled in that there is no cooling element to reduce and stabilize the temperature of the laser 120. In other words, the laser heater 132 maintains the operating temperature of the laser 120 above the temperature floor such that the operating temperature is allowed to rise above the temperature floor without cooling of the laser 120.

The laser heating system 130 may also include a temperature sensor 134 that senses a temperature of the laser 120 or in a region around the laser 120. The temperature sensor 134 may be coupled to the laser heater 132, for example, through laser heater circuitry. The temperature sensor 134 may cause the laser heater 132 to heat the laser 120 when the sensed temperature indicates that the operating temperature of the laser 120 is below the temperature floor and may cause the laser heater 132 to stop heating when the sensed temperature indicates that the operating temperature of the laser 120 is above the temperature floor. To control the heater 132, for example, the temperature sensor 134 may be coupled to a switch 136 that couples the current from the laser circuitry 110 to the laser heater 132. The switch 136 may be used to switch the heater 132 on when the sensed temperature indicates that the operating temperature is below the temperature floor and to switch the heater 132 off when the sensed temperature indicates that the operating temperature is above the temperature floor.

According to one example of a laser 120 having a wavelength temperature fluctuation of about 0.1 to 0.12 nm per degree Celsius, the operating temperature range may be reduced to cover about 90° C. or less to limit the wavelength shift to a maximum of about 11 nm. If the maximum operating temperature is expected to be about 85° C., for example, the heater 132 may be used to maintain an operating temperature above a temperature floor of about −5° C. to limit the operating temperature range to about −5° C. to 85° C. (e.g., as compared to −40° C. to 85° C.). In other words, the laser heater 132 may be switched on when the sensor 134 senses a temperature of below −5° C. and the laser heater 132 may be switched off when the sensor 134 senses a temperature above −5° C. Thus, a conventional wavelength variation of about 13-14 nm for a temperature operating range of −40° C. to 85° C. could be reduced significantly without using a thermoelectric cooler. Other temperature floors (e.g., about 0° C.) and operating temperature ranges may be used depending upon the wavelength temperature fluctuation, manufacturing tolerances, and other characteristics of the laser and depending upon the acceptable amount of wavelength shift that may be tolerated in the optical communications system.

According to one embodiment, as shown in FIG. 2, a laser package 200 may include a semiconductor laser 220 and laser heater 230 housed in a laser package housing 210. The laser package housing 210 may optically couple the laser 220 to an optical fiber 202 and may be electrically coupled to laser circuitry (not shown). The laser 220 may be mounted on a laser submount 212 disposed within the laser package housing 210. The laser heater 230 may also be disposed on the laser submount 212 adjacent to or sufficiently close to the laser 120 or in some other location where the heater 230 is capable of increasing the operating temperature of the laser 220.

In the illustrated exemplary embodiment, the laser package 200 is a TO (transistor outline) can laser package and the laser package housing 210 is a TO can housing. The TO can housing 210 aligns and positions the laser 220, fiber 202 and related optical components to each other so that the laser 220 is optically coupled to the fiber 202. In this embodiment, the TO can housing 210 may include a TO can header 214 with a TO can post 216, and the laser 220 is mounted on the laser submount 212 located on the TO can post 216 of the TO can header 214.

In this exemplary embodiment, the laser heater 230 may include a film resistor 232 with electrical terminals or leads 234 coupled to the film resistor 232. The electrical leads 234 may be coupled to a current source (e.g., laser circuitry) for applying current to the film resistor 232. The leads 234 may also be coupled to a temperature sensor and/or switch (not shown) for switching the current to the film resistor 232 on and off in response to sensing an operating temperature below or above a temperature floor, as disclosed above. The relatively small size of the film resistor 232 needed to provide the desired heating (e.g., as compared to a TEC) allows the use of smaller housings, such as the TO can housing. Thus, a heated laser package, consistent with embodiments of the present invention, may reduce temperature drift and wavelength shift while being less expensive, less complex and more compact than conventional temperature-stabilized lasers.

In one embodiment, the film resistor 232 may be formed by a resistance material deposited directly on the laser submount 212, for example, near the location of the laser 220. One advantage of a deposited film resistor is the ability to precisely control resistance, for example, by laser trimming the film resistor using techniques known to those skilled in the art. The resistance material may include a nickel-chromium resistance material, such as NiChrome™, which is a non-magnetic alloy of nickel and chromium. Other film resistors may include, but are not limited to, carbon film resistors, metal film resistors, metal oxide resistors, and metal nitride resistors, such as tantalum nitride. In addition to being formed by depositing a resistance material, the film resistor 232 may be formed as a chip resistor that may be mounted to the submount 212. Other types of resistors that can be used for heaters include, but are not limited to, carbon composition resistors and wire wound resistors.

Because the laser 220 is relatively small and the film resistor 232 can be placed close to the laser 220, a relatively small amount of current is needed to cause the film resistor 232 to generate the desired amount of heat. In one exemplary application, the film resistor 232 may be capable of providing the desired amount of heat from a current (e.g., the operating current of the laser) of less than about 500 mA and with a power consumption of less than about 1.5 W. Those skilled in the art will recognize the desired resistance value of the film resistor based on current, power consumption, and the desired temperature floor for a particular laser and application.

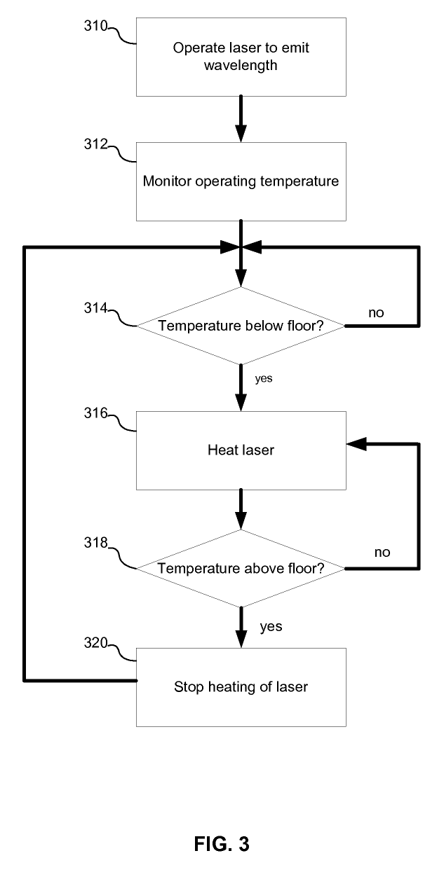

Referring to FIG. 3, one embodiment of a method of reducing an operating temperature range of a laser is described. This method of reducing the operating temperature of the laser may be used with various types of laser packages and laser transmitters. According to the method, the laser is operated 310 to emit a wavelength. The laser may be operated, for example, by providing electrical signals to the laser to generate a laser output at the emission wavelength. When the laser is operating, an operating temperature of the laser is monitored 312. The operating temperature of the laser may be monitored, for example, by sensing a temperature of the laser or the temperature in a region around the laser or laser package, as described above.

If the operating temperature of the laser is determined to fall below the temperature floor 314, the laser is heated 316. The laser may be heated, for example, by switching on a laser heater, as described above. If the operating temperature is not determined to fall below the temperature floor, monitoring of the temperature continues without heating the laser. When the laser is being heated 316, if the operating temperature is determined to rise above the temperature floor 318, heating of the laser is stopped 320. Heating may be stopped 320, for example, by switching off the laser heater, as described above. After heating is stopped 320, the temperature may be allowed to rise above the temperature floor without cooling the laser, but if the temperature again falls below the temperature floor 314, heating 316 is resumed. The monitoring of the temperature, heating and stopping heating may continue during operation of the laser to maintain the operating temperature of the laser above the temperature floor such that the operating temperature of the laser is allowed to vary within a reduced operating temperature range and the wavelength emitted by the laser is allowed to vary within a reduced range of emission wavelengths.

Accordingly, a laser package, laser transmitter and method of reducing an operating temperature of a laser, consistent with embodiments of the present invention, are capable of reducing wavelength excursion or fluctuation of a laser by preventing temperature drift below a temperature floor.

Consistent with one embodiment, a laser package for use in a laser transmitter includes a semiconductor laser configured to emit a predefined center wavelength and a range of wavelengths around the center wavelength. The laser has a wavelength temperature fluctuation such that an emission wavelength of the laser varies with an operating temperature of the laser. The laser package further includes a laser heater for heating the semiconductor laser. The laser heater is configured to maintain the operating temperature of the laser above a temperature floor such that the operating temperature of the laser is allowed to vary within a reduced operating temperature range and the wavelength emitted by the laser is allowed to vary within a reduced range of emission wavelengths.

Consistent with another embodiment, an optical transmitter includes laser circuitry and a laser package coupled to the laser circuitry. The laser package includes a semiconductor laser configured to emit a predefined center wavelength and a range of wavelengths around the center wavelength. The laser has a wavelength temperature fluctuation such that an emission wavelength of the laser varies with an operating temperature of the laser. The laser package further includes a laser heater for heating the semiconductor laser. The laser heater is configured to maintain the operating temperature of the laser above a temperature floor such that the operating temperature of the laser is allowed to vary within a reduced operating temperature range and the wavelength emitted by the laser is allowed to vary within a reduced range of emission wavelengths.

Consistent with a further embodiment, a method is provided for reducing an operating temperature range of a laser. The method includes operating the laser to emit a wavelength that varies with an operating temperature of the laser; monitoring the operating temperature of the laser; heating the laser when the operating temperature falls below a temperature floor; and stopping the heating of the laser when the operating temperature rises above the temperature floor. The operating temperature of the laser is allowed to rise above the temperature floor without cooling the laser.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A laser package for use in an optical transmitter, comprising:
a semiconductor laser configured to emit a predefined center wavelength and a range of wavelengths around the center wavelength, wherein the laser has a wavelength temperature fluctuation such that an emission wavelength of the laser varies with an operating temperature of the laser; and
a laser heater for heating the semiconductor laser, the laser heater being configured to maintain the operating temperature of the laser above a temperature floor such that the operating temperature of the laser is allowed to vary within a reduced operating temperature range and the wavelength emitted by the laser is allowed to vary within a reduced range of emission wavelengths.

2. The laser package of claim 1 wherein the temperature floor is at least about −5° C.

3. The laser package of claim 1 wherein the reduced temperature range covers about 90° C. or less.

4. The laser package of claim 1 wherein the semiconductor laser is uncooled.

5. The laser package of claim 1 wherein the heater is configured to operate with a current of less than about 100 mA.

6. The laser package of claim 5 wherein the heater is configured to operate with a power consumption of less than about 1.5 W.

7. The laser package of claim 1 further comprising a laser submount, wherein the laser heater is disposed on the laser submount.

8. The laser package of claim 7 wherein the laser heater includes a resistance material deposited directly on the submount and electrical leads electrically coupled to the resistance material.

9. The laser package of claim 7 wherein the laser heater includes a tantalum nitride resistance material deposited directly on the submount and electrical leads electrically coupled to the tantalum nitride resistance material.

10. The laser package of claim 7 further comprising a TO can housing, wherein the laser submount, the semiconductor laser and the laser heater are disposed within the TO can housing.

11. An optical transmitter comprising:
laser circuitry; and
a laser package coupled to the laser circuitry, the laser package comprising:
a semiconductor laser configured to emit a predefined center wavelength and a range of wavelengths around the center wavelength, wherein the laser has a wavelength temperature fluctuation such that an emission wavelength of the laser varies with an operating temperature of the laser; and
a laser heater for heating the semiconductor laser, the laser heater being configured to maintain the operating temperature of the laser above a temperature floor such that the operating temperature of the laser is allowed to vary within a reduced operating temperature range and the wavelength emitted by the laser is allowed to vary within a reduced range of emission wavelengths.

12. The optical transmitter of claim 11 further comprising:
a temperature sensor coupled to the laser heater, the temperature sensor being configured to cause the laser heater to switch on when the temperature sensor senses a temperature below a threshold corresponding to the temperature floor.

13. The optical transmitter of claim 11 wherein the temperature floor is at least about −5° C.

14. The optical transmitter of claim 11 wherein the laser package includes a laser submount, and wherein the laser heater includes a resistance material deposited directly on the submount and electrical leads electrically coupled to the resistance material.

15. A method of reducing an operating temperature range of a laser, the method comprising:
operating the laser to emit a wavelength that varies with an operating temperature of the laser;
monitoring the operating temperature of the laser;
heating the laser when the operating temperature falls below a temperature floor; and
stopping the heating of the laser when the operating temperature rises above the temperature floor, wherein the operating temperature of the laser is allowed to rise above the temperature floor without cooling the laser.

16. The method of claim 15 wherein the temperature floor is at least about −5° C.

17. The method of claim 15 wherein the laser has an operating temperature range that covers about 90° C. or less.

18. The method of claim 15 wherein heating the laser includes providing a current to a film resistor.

19. The method of claim 18 wherein the current is less than about 100 mA.

20. The method of claim 18 wherein stopping the heating of the laser includes preventing the current from being provided to the film resistor when a temperature sensor senses a temperature above a threshold corresponding to the temperature floor.
